(19) United States
(12) Patent Application Publication
(10) Pub. No.: US 2016/0055263 A1
(43) Pub. Date: Feb. 25, 2016

(54) Providing Action Search and Quick Action Cards

(71) Applicant: SuccessFactors, Inc., South San Francisco, CA (US)

(72) Inventors: Dominic Philip Haine, So. San Francisco, CA (US); Scott McGhee, So. San Francisco, CA (US); Satyajit Das, So. San Francisco, CA (US)

(21) Appl. No.: 14/812,795

(22) Filed: Jul. 29, 2015

Related U.S. Application Data
(60) Provisional application No. 62/040,839, filed on Aug. 22, 2014.

(51) Int. Cl. G06F 17/30

(52) U.S. Cl. CPC G06F 17/30985; G06F 17/30991; G06F 17/30997

(57) ABSTRACT

Described herein are techniques for a search feature within a business suite. The business suite includes one or more software applications configured to interoperate with one another. The one or more software applications can perform business functions which support the core business of the organization. The search feature receives a search query from a user and matches the search query to matching paraphrases (i.e., keywords) of actions in an actions database. If a match is found between a matching paraphrase and the search query, a presentation paraphrase that corresponds with the matching paraphrase is presented as part of a search result. Subsequent selection of the presentation paraphrase can cause the action to be executed.

### CROSS-NOTING TO RELATED APPLICATIONS

This application claims the benefit of U.S. Application No. 62/040,839, filed Aug. 22, 2014, entitled “PROVIDING ACTION SEARCH AND QUICK ACTION CARDS”, which is incorporated herein by reference in its entirety.

### BACKGROUND

A business suite is a collection of business software functions that support the core business of an organization. As business suites mature, the number of business functions that can be performed by the business suite grow over time. While increasing the number of business functions result in improved functionality, navigating to a desired action or task within the business suite can become more cumbersome due to the increase in the number of business functions. For example, navigating to a desired action can initially require recursively navigating through two menus or pages. As the business suite grows, navigating to the same desired action can require recursively navigating through three menus or pages.

### SUMMARY

In one embodiment, a computer-implemented method receives, by a processor, a search query. The method then matching, by the processor, the search query to an action in an actions database by matching at least a portion of at least one keyword associated with the action to the search query, wherein the action is configured to perform a task in a software application, or navigate to a place where such task may be completed by the user. The method then presents, by the processor, a presentation paraphrase of the action as part of a search result. The method then receives, by the processor, user input representative of selecting the presentation paraphrase from the search result. The method then performs, by the processor, the action in response to the user input.

In one example, the method can further match, by the processor, the search query to an employee within an organization by comparing a name of the employee to the search query and present, by the processor, the name of the employee within the organization as part of the search result.

In another example, the action card includes a many-to-one mapping between a plurality of keywords and the presentation paraphrase.

In another example, the action is a deep link into the software application. The search query can be received from an employee and the action can provide a deep link along with one or more parameters describing the employee.

In another example, performing the action includes presenting, by the processor, an action card configured to receive data to perform the task, receiving, by the processor, user input representative of entering the data into the action card, and passing, by the processor, the data to the software application to perform the task.

In another example, the search query is submitted by a user and performing the action includes determining, by the processor, that the action is a transitive action to be performed on another user, querying, by the processor, an employee database for a list of users that directly report to the user submitting the search query, and presenting, by the processor, the list of users in conjunction with the presentation paraphrase.

In another embodiment, a non-transitory computer readable storage medium stores one or more programs comprising instructions for receiving a search query, matching the search query to an action in an action database by matching at least a portion of at least one keyword associated with the action to the search query, wherein the action is configured to perform a task in a software application, presenting a presentation paraphrase a matched keyword of the action as part of a search result, receiving user input representative of selecting the presentation paraphrase from the search result, and performing the action in response to the user input.

In another embodiment, a computer implemented system comprises one or more computer processors and a non-transitory computer-readable storage medium. The non-transitory computer-readable storage medium comprises instructions, that when executed, control the one or more computer processors to be configured for receiving a search query, matching the search query to an action in an action database by matching at least a portion of at least one keyword associated with the action to the search query, wherein the action is configured to perform a task in a software application, presenting a presentation paraphrase a matched keyword of the action as part of a search result, receiving user input representative of selecting the presentation paraphrase from the search result, and performing the action in response to the user input.

The following detailed description and accompanying drawings provide a better understanding of the nature and advantages of the present disclosure.

### BRIEF DESCRIPTION OF THE DRAWINGS

FIG. 1 illustrates a system for providing a quick action feature according to one embodiment;

FIG. 2 illustrates a system for modifying actions according to one embodiment;

FIG. 3 illustrates a user interface for managing an action according to one embodiment;

FIG. 4 illustrates a system for executing a search query according to one embodiment;

FIG. 5 illustrates an execution of an action search according to one embodiment;

FIG. 6a illustrates another execution of an action search according to one embodiment;

FIG. 6b illustrates the window of FIG. 6a after selecting a presentation paraphrase to request vacation time off according to one embodiment;

FIG. 7 illustrates an example of a configuration of an action according to one embodiment;

FIG. 8a illustrates another execution of an action search according to one embodiment;

FIG. 8b illustrates the window of FIG. 8a after selecting the presentation paraphrase to show learning plan for a person within the organization according to one embodiment;

FIG. 9 illustrates a process according to one embodiment; and

FIG. 10 illustrates an exemplary computer system according to one embodiment.

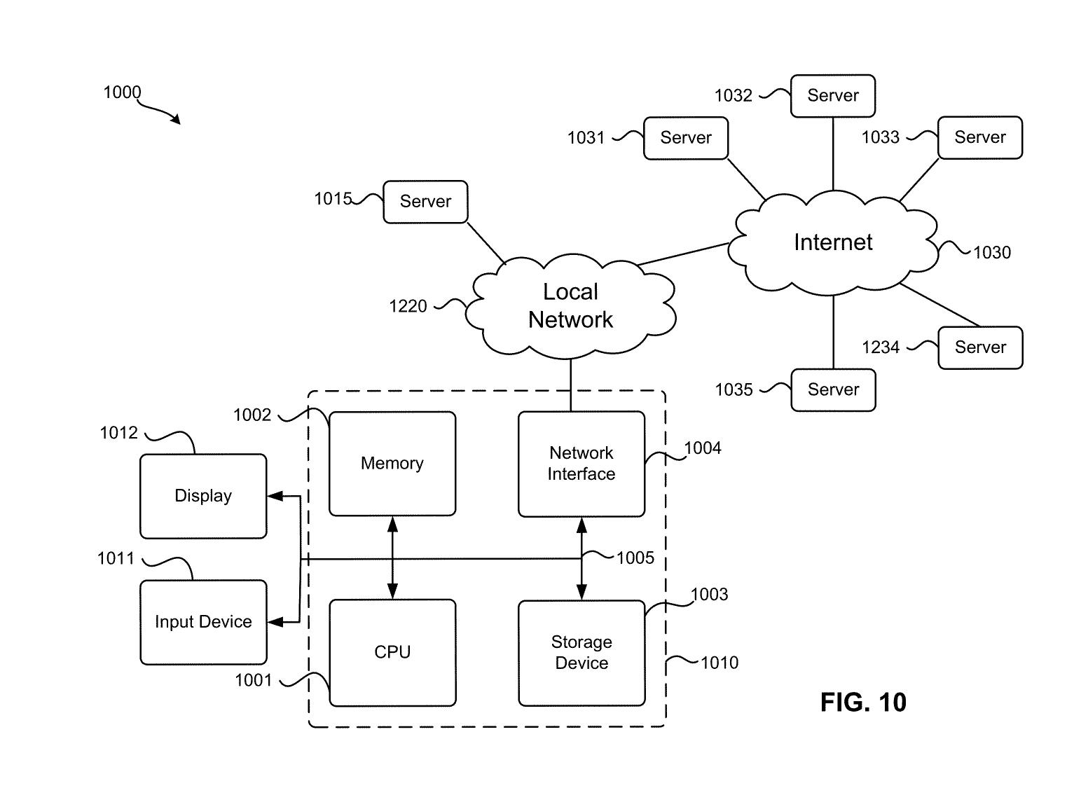

### DETAILED DESCRIPTION

In the following description, for purposes of explanation, numerous examples and specific details are set forth in order to provide a thorough understanding of the present disclosure. It will be evident, however, to one skilled in the art that the present disclosure as expressed in the claims may include some or all of the features in these examples alone or in combination with other features described below, and may further include modifications and equivalents of the features and concepts described herein.

Described herein are techniques for a search feature within a business suite. The business suite includes one or more software applications configured to interoperate with one another. The one or more software applications can perform business functions which support the core business of the organization. The business suite includes a dashboard that presents information to a user of the business suite. The dashboard can include a search module. In one embodiment, the search module can be configured to search for people within the organization. Once a person is located, personal information on the person can be presented within the dashboard. In another embodiment, the search module can be configured to search for actions which can be performed by the user. Once an action is located, the search module can deep link the user into the business suite, thus allowing the user quick access to the action without following traditional navigation techniques of clicking through the navigation menus. Alternatively, the search module can present an action card (e.g., dialog box) that has been tailored to perform a particular task, such as requesting time off. In some embodiments, the search module can be configured to search for people and actions simultaneously. Therefore if an action pertains to a particular person, and a person's name is provided, the search module can present personal information on the person and if an action is provided, the search module can process the action on the person accordingly. The search module can generate a search bar that can be presented within the dashboard. When a user enters one or more search parameters in the form of keystrokes into the search bar, the search module can analyze the search parameters to identify the desired person or action. Through the user of the search module, the user is able to utilize a single search bar to locate information on a person of interest and to perform an action of interest.

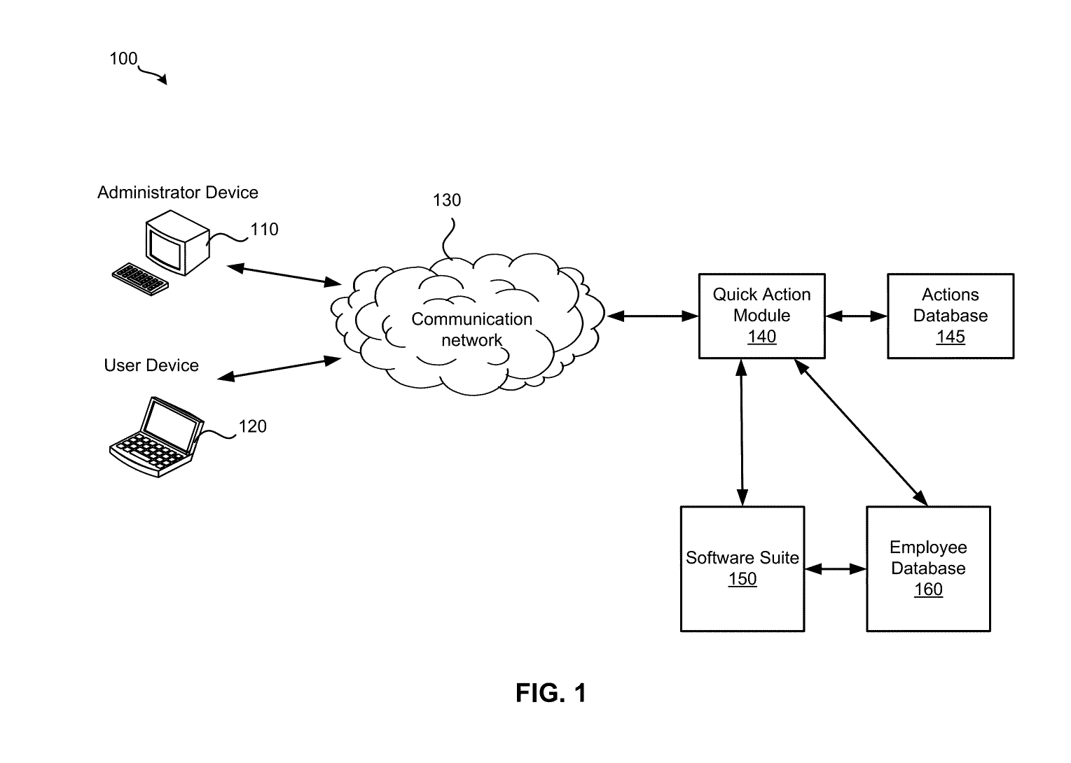

FIG. 1 illustrates a system for providing a quick action feature according to one embodiment. System 100 includes administrator device 110, user device 120, communication network 130, quick action module 140, actions database 145, software suite 150, and employee database 160. Quick action module 140 can be configured to quickly locate information stored in employee database 160, quickly perform a task within software suite 150, or both. To perform a task, quick action module 140 can communicate with actions database 145 to access actions. Each action can be related to a task available in the software suite. Exemplary tasks include requesting time off, assigning a bonus to an employee or direct report, and assigning raises to an employee or direct report. An exemplary action that is related to the task of requesting time off can be deeply linking the user to a module within software suite 150 where the user can enter the details of the requested time off. Another exemplary action that is related to the task of requesting time off can be to provide an action card here details of the requested time off can be entered. An action card is a user interface in the form of a pop up dialog box. The action card can be used to collect information for performing an action. Thus, the user can enter the information into the dialog box rather than a conventional form that is related to the action. This allows the user to enter the information without moving to a different screen. In both scenarios, time can be saved since quick action module 140 is assisting the user in minimizing the steps that need to be performed the desired task. As a result, quick action module 140 is advantageous over conventional methods which require the user to navigate through software suite 150 until the desired module to perform the desired task is reached. Advantages of this system include exposing the user to actions which the user may not be aware that the action even exists. For example if a manager types “time” they might see a previously unknown action to “manage time off on behalf of . . . ” an employee who may be unable to do so themselves (e.g. because they are sick), or an action to “view team time off”, which shows a concise view of who on the team is taking time off over the coming weeks.

In some embodiments, quick action module 140 can be implemented as a search bar. The search bar can be configured to receive user input in the form of a search query. Quick action module 140 can process the search query to return a list of search results. In one example the search results can include information such as a list of employees within an organization whose name is a match or a partial match for the search query. In another example, the search results can include tasks of the software suite 150 which are a match or a partial match with the search query. In some embodiments, the search bar can be presented as part of a user dashboard. The user dashboard can include a menu bar plus one or more tiles which are used to present information that is of interest to the user. By clicking through the tiles or the menu bar, the user can navigate to the desired task. This can take multiple clicks as the user navigates through menus and submenus in the software suite 150 to reach the desired task. Alternatively, the user can enter a search query that describes the desired task. If successful, quick action module 140 can return a list of search results that includes an action associated with the desired task. By selecting the action, application can deep link the user to the desired task within software suite 150 or alternatively can provide an action card in the form of a pop up box. The pop up box can include one or more fields configured to receive parameters for the desired task. Once the dialog box has been populated, quick action module 140 can perform the desired task. In both approaches, quick action module 140 simplifies and reduces the amount of time required to perform the desired task, thus resulting in a more pleasant user experience.

Administrator device 110 can communicate with quick action module 140 via communication network 130 to create or modify action cards. Each action card can be configured to perform an action related to a task available by software suite 150. Once the action cards are configured, user device 120 can send requests to quick action module 140 via communication network 130. The requests can be received via a search bar that is implemented by quick action module 140. As shown here, quick action module 140, actions database 145, software suite 150, and employee database 160 reside remotely of administrator device 110 and user device 120. As a result, these devices communicate with quick action module 140 through communication network 130. However in other embodiments, one or more of quick action module 140, actions database 145, software suite 150, and employee database 160 can reside within administrator device 110 or user device 120. For instance, a copy of quick action module 140 can be executed locally within administrator device 110 and user device 120. During execution, quick action module 140 can access actions database 145, software suite 150, and employee database 160 via communication network 130. In some examples, employee database can be used for performing transitive actions (e.g., actions which are performed on a person or thing). Other databases such as reports databases and candidate databases can also be utilized to perform transitive actions.

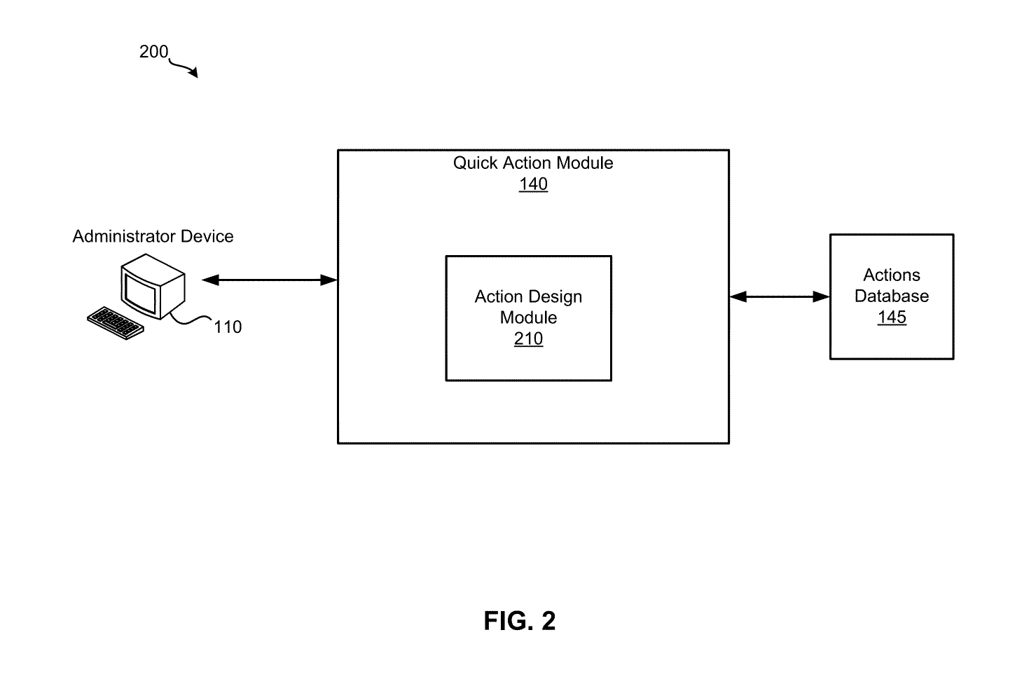

FIG. 2 illustrates a system for modifying actions according to one embodiment. As shown, system 200 includes administrator device 110, actions database 145, and quick action module 140, which includes action card design module 210. Action card design module 210 can be configured to create, modify, or delete action cards from actions database 145. In one example, administrator device 110 can transmit requests to create, modify, or edit an action card to action card module 210. Action card design module 210 can process the request and create, modify, or delete an action card.

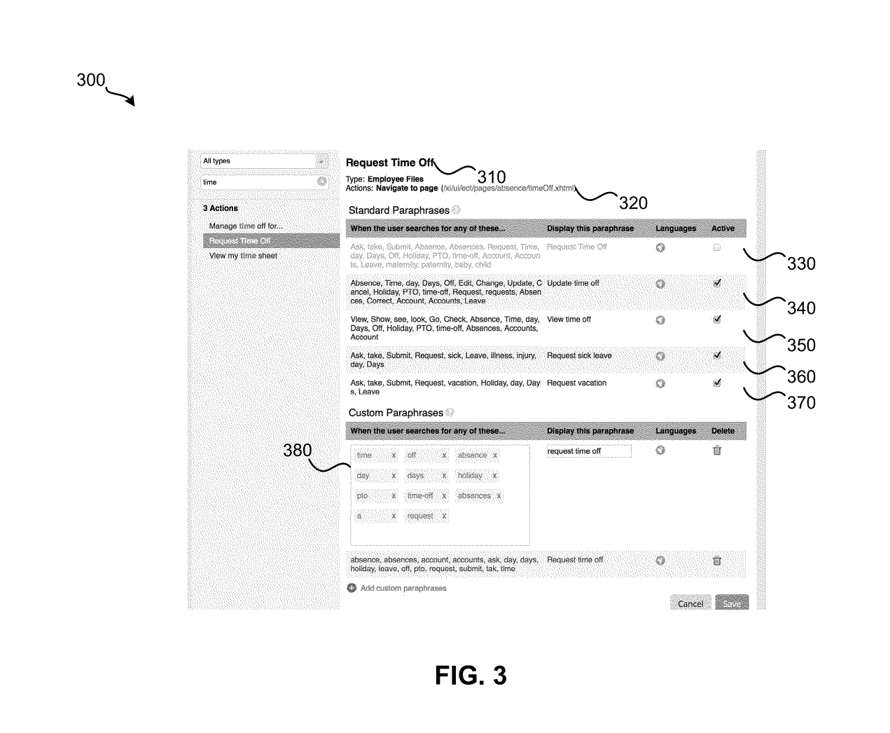

FIG. 3 illustrates a user interface for managing an action according to one embodiment. User interface 300 can be presented by action design module 210 to administrator device 110 for editing an action. User interface 300 can include title 310 (e.g., “Request Time Off”) to store the name of the action. User interface 300 further includes multiple paraphrases (e.g., paraphrase 330, 340, 350, 360, and 370). Each paraphrase can include matching paraphrases, also known as keywords. Matching paraphrases are terms of what the user is searching for. If a matching paraphrase is a match (or is a partial match) to the user's search query, then corresponding paraphrase is triggered. Triggered paraphrases are presented to the user as part of the search results. Each paraphrase also includes a presentation paraphrase. During presentation of the search results, a presentation paraphrase that corresponds with the matching paraphrase is presented to the user. For example, paraphrase 360 specifies that the presentation paraphrase “Request vacation” should be presented as a search result if a search query contains any of the matching paraphrases “ask, take, submit, request, sick, leave, illness, injury, day, days”. Each paraphrase can also include a languages setting where the matching paraphrases and the presentation paraphrases can be set for different languages. Each paraphrase can also include an active flag to specify whether the paraphrase is active. User interface 300 can include standard paraphrases (paraphrases 330, 340, 350, 360, and 370) and also custom paraphrase 380. Custom paraphrase can be configured by the user, thus allowing a customer to create customized paraphrases. As shown, custom paraphrase 380 includes multiple matching paraphrases that have been user defined and also a presentation paraphrase that has been user defined. In some embodiments, the actions can also be customizable by the user.

If the presentation paraphrase is selected, action 320 associated with the action can be executed. Here, action 320 is a deep link within the software suite to a page for managing requests for time off. Through use of the matching paraphrases and the presentation paraphrases, a more intuitive user experience is provided. If a user enters a search query for “holiday”, the search results would include “update time off,” “view time off,” or “request vacation.” In contrast if the user enters a search query for “sick,” the search results would include “Request sick leave.” Although selecting any of these search results would lead to action card 300 and ultimately the execution of action 320, the presentation of the search results have been tailored based on the search query. This can reduce confusion resulting from generic search results or search results which are not related to what the user is searching for. For instance, it would be confusing for a user entering a search query of “sick leave” to be presented with a search result of “request vacation,” even though all requests for sick leave and vacation are handled by the same web page. User interface 300 can also include user-defined paraphrases. As shown, custom paraphrase 380 includes multiple matching paraphrases and a presentation paraphrase.

In some embodiments, user interface 300 can specify one or more parameters to pass along action 320. In one embodiment, attributes or metadata of the user requesting the search query can also be passed along with the deep link. This can be particularly useful if the deep link is to a form that is to be filled out since fields within the form can be automatically populated with the user's metadata such as the user's name, address, phone number, bank information, or other. In another embodiment, parameters can be passed along with action 320 based on the paraphrase that is triggered. For instance, triggering paraphrase 370 can imply that the user wishes to request vacation days. As a result, quick action module 140 can pass along one or more parameters with action 320 to set one or more fields within the web page to configure the web page for requesting vacation days versus requesting sick days. For example, a field can be set to specify that the request for time off is for vacation days rather than sick days. In yet another embodiment, action 320 can be to present a pop up window or dialog box having fields for collecting data. The window or dialog box can provide a simple user interface for the user to perform the action. For example, a pop up window can include fields for selecting the days to request off. The user interface can be an option instead of navigating to the time off page to enter details for requesting time off.

As shown here, there can be a many-to-one mapping between a paraphrase's matching paraphrases (i.e., keywords) and the paraphrase's presentation paraphrase. As a result, matching any of the matching paraphrases to a search query can return the presentation paraphrase. For example, a search query containing the word “vacation,” “holiday,” or “submit” can all return the “request vacation” presentation paraphrase as shown in paraphrase 370. Similarly, an action can contain different paraphrases that have the same matching paraphrase. As a result, entering a search query can in turn return multiple presentation paraphrases. For example, a search query containing the word “absence” can return presentation paraphrases “request time off” (of paraphrase 330), “update time off” (of paraphrase 340), and “view time off” (of paraphrase 350). This can allow the search result to be more user friendly since multiple presentation paraphrases can be presented in hopes that one of them matches well with what the user is searching for. Advantages of this include improving the user experience and minimizing user confusion. In some examples, the matching paraphrase can contain words that do not appear in the presentation paraphrase. For example, paraphrase 370 includes a matching paraphrase (“submit”) that does not appear in the presentation paraphrase (“Request vacation”). Thus, terms in the search query may not appear in the search results since the terms are not in the presentation paraphrase.

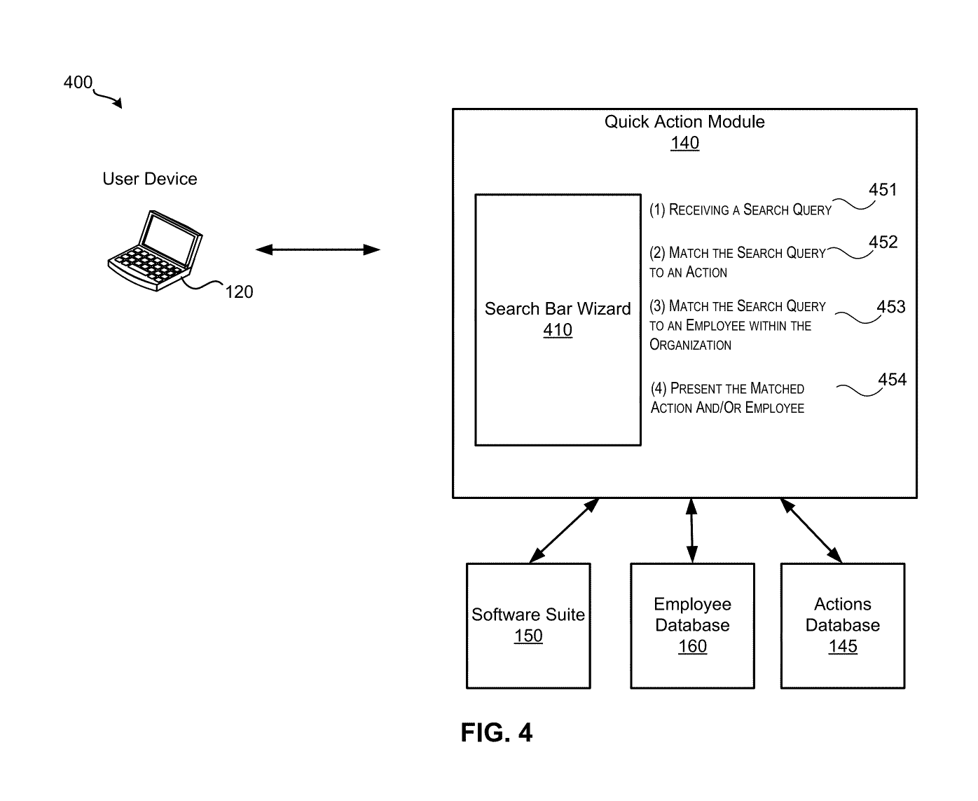

FIG. 4 illustrates a system for executing a search query according to one embodiment. As shown, system 400 includes user device 120, software suite 150, employee database 160, actions database 145, and quick action module 140, which includes search bar wizard 410. Search bar wizard 410 is configured to generate a search bar for receiving a search query. Based on the search query, search bar wizard 410 can identify information or actions that match (or partially match) the search query. For instance, search bar wizard 410 can match the search query against employee names in employee database 160. As a result, employees having a name that at least partially matches the search query can be identified as returned in the list of search results (search query for “mo” would return employees named “Molos Lewis,” “Morla Grant,” “Molly Hinders”).

Search bar wizard 410 can begin by receiving a search query at step (1) (reference numeral 451). The search query can be received within a search bar generated by quick action module 140 or search bar wizard 410. Once the search query is received, search bar wizard 410 can match the search query to an action at step (2) (reference numeral 452). In one embodiment, each action in actions database 145 can include multiple paraphrases that each include at least one matching paraphrase and a presentation paraphrase. Each matching paraphrase an accepted keyword or phrase that a user may enter when attempting to search for or trigger the action. Search bar wizard 410 can attempt to match the search query to an action by matching the search query to the corresponding paraphrases of the action. In one embodiment, search bar wizard can filter the available actions that are available to the user of user device 120. The availability of an action can depend on user licenses or user configurations. Search bar wizard 410 can optionally continue by matching the search query to an employee within the organization at step (3) (reference numeral 453). To match the employee, search bar wizard 410 can query an employee database for employees that have a name that at least partially matches the search query. Once the matches have been found, search bar wizard 410 can present the matched actions and/or employees. In one embodiment, a list of search results can be presented as a drop down menu from the search bar. The drop down menu can optionally include a divider to separate the search results that are actions from the search results that are employees.

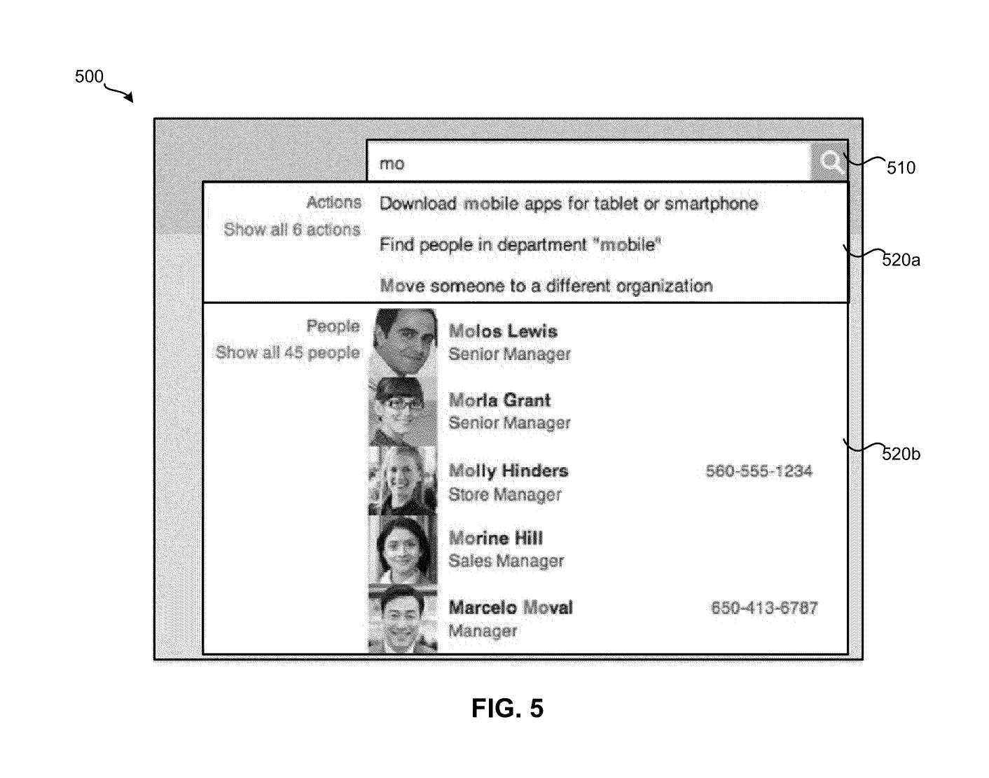

FIG. 5 illustrates an execution of an action search according to one embodiment. Window 500 includes search bar 510. Search bar 510 is configured to receive a search query. The search query is a keyword provided by a user searching for a particular task or employee within the organization. Here, the keyword “mo” has been received as the search query. Search bar wizard 410 processes the search query (e.g., keyword “mo”) and returns a list of search results that includes actions and employees who are at least a partial match to the search query. Here, results list 520 is separated into two sections: actions list 520a and people list 520b. Search bar wizard 410 can generate actions list 520a by matching the search query to actions in actions database 145. As shown, there are six actions in the results list but only three are shown due to the size of actions list 520a. Selecting the “show all 6 actions” icon can result in the expansion of actions list 520a so that all six actions can be presented simultaneously. Search bar wizard 410 can match the search query to employees within the organization. Alternatively, search bar wizard 410 can communicate with another module to perform the employee search. Search bar wizard 410 can present the employee results in people list 520b. Detecting a selection of the “show all 45 people” icon can result in search bar wizard 410 displaying all of the employee results simultaneously. In some embodiments, the search results can be dynamically updated as the search query changes. For example, adding another character to the search query to change the search query from “mo” to “mor” would return a subset of the employee results (e.g., the employee results that partially match “mor”) while removing a character from the search query to change the search query from “mo” to “m” would return a new list of employee results that may be larger than the original list for “mo.” In other embodiments, search bar wizard 410 can be configured to quickly identify elements within a page or image. For example, search bar wizard 410 can match a search query to elements within a displayed image or page. Each element can be associated with a keyword. Search bar wizard 410 can match the keywords to the search query. The elements that are associated with the matched keywords can be identified as the matched elements. In some examples, search bar wizard 410 can highlight, activate, pop out, or select the matched elements. In one example, matched elements can be highlighted while unmatched elements can be dimmed, thus allowing the user to focus in on the matched elements

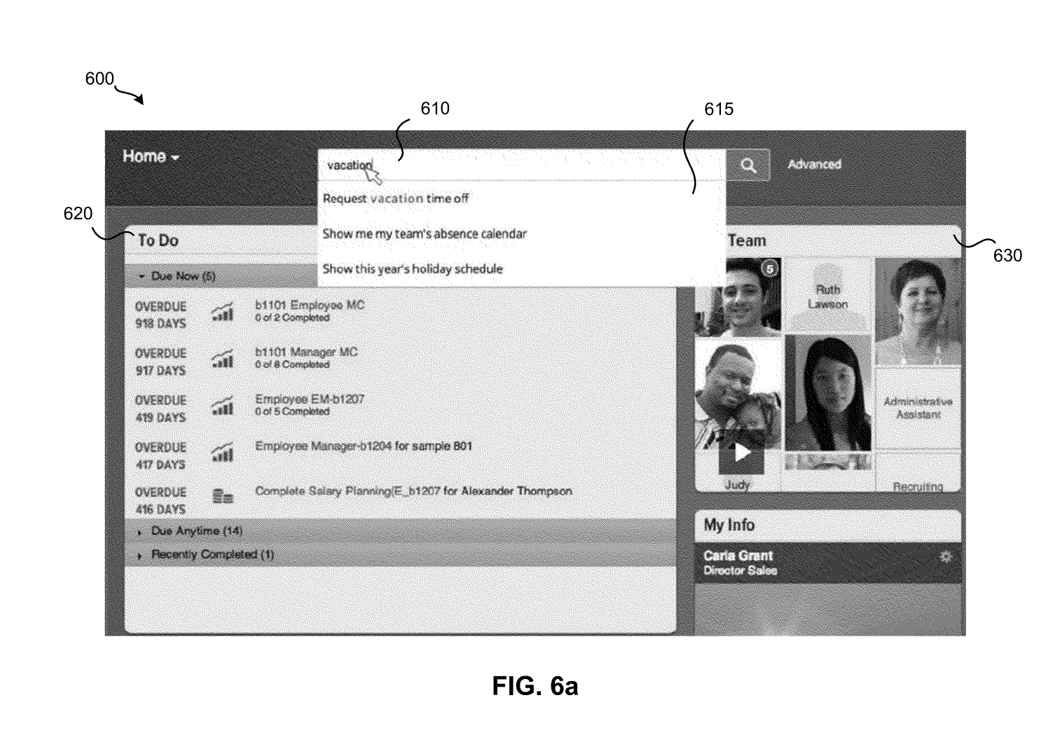

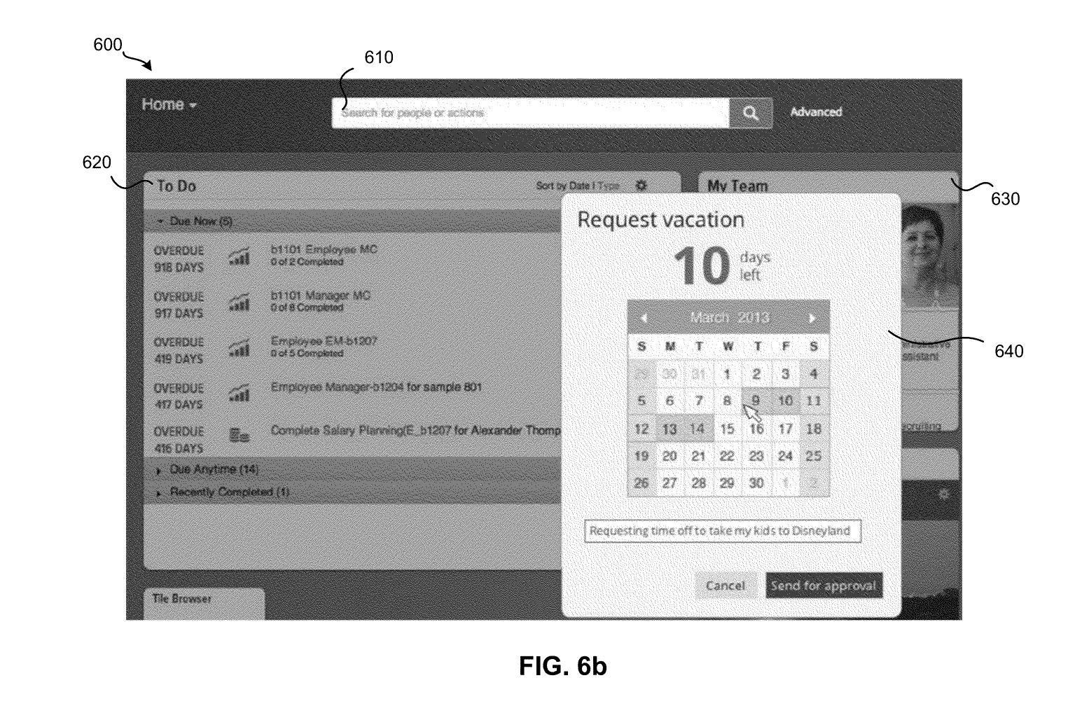

FIG. 6a illustrates another execution of an action search according to one embodiment. Window 600 belongs to a user and includes search bar 610, tile 620 (“To Do”), and tile 630 (“My Team”). Quick action module 140 can process a user entered search query (“vacation”) in search bar 610 and return presentation paraphrases of actions which match the search query. As shown, quick action module 140 has returned three search results in drop down box 615. Drop down box 615 that contains the search results can overlay existing tiles within window 600. Here, drop down box 615 overlays portions of tile 620 and tile 630.

FIG. 6b illustrates the window of FIG. 6a after selecting a presentation paraphrase to request vacation time off according to one embodiment. Here, a selection has been made from the search results to request vacation time off. As a result, quick action module 140 can perform an action that is associated with the presentation paraphrase “request vacation time off.” Here, the action is to present an action card as a pop up dialog box. The dialog box 640 can include a user interface to specify the desired vacation time off. In this example, the action card 640 is a calendar configured to allow the user to select the desired days off plus a description of the reasoning for the vacation time off. Once the specifics have been provided, quick action module 140 can transmit the request for approval. Advantages of using the search bar include a reduction in steps to request time off. Rather than manually navigating to the page where the user can request time off, the user can instead enter the keyword “vacation” in the search bar and automatically be presented a dialog box where details on the requested vacation can be entered and the vacation request can be sent in for approval.

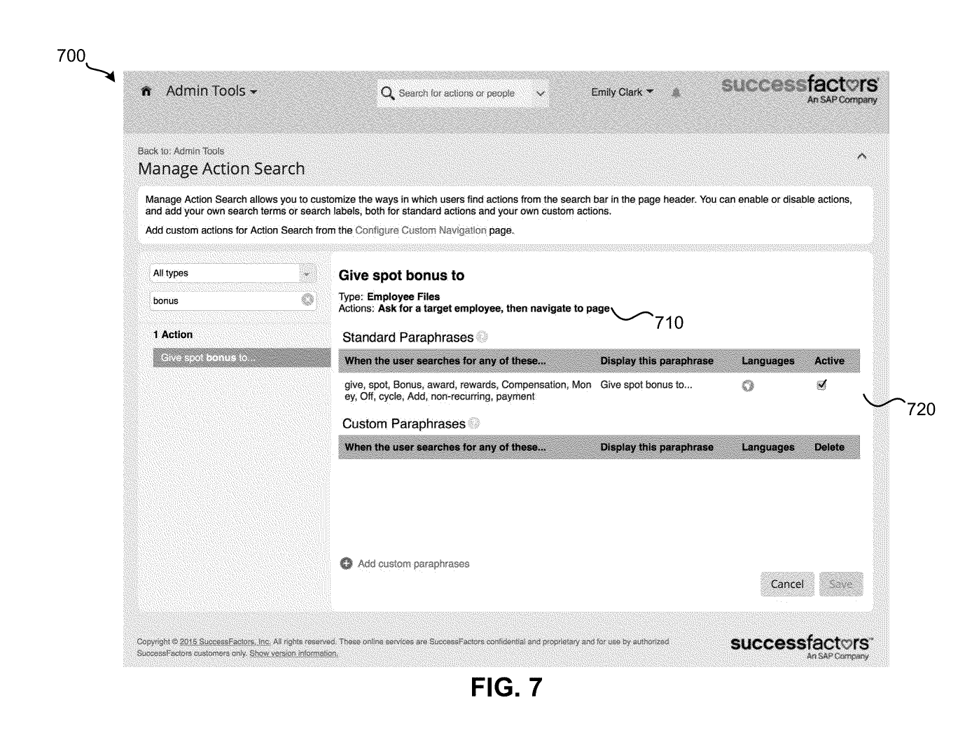

FIG. 7 illustrates an example of a configuration of an action according to one embodiment. Action card 700 includes action 710. Action 710 is an example of a transitive action. A transitive action is an action that is performed on an object. The object can be an employee within the organization, a team within the organization, a group within the organization, or inanimate objects such as conference rooms and offices that belong to the organization, to name a few. Since the action is being performed on an object, search bar wizard 410 (or quick action module 140) can request that the object be specified before the action can be executed. Here, action 710 is a transitive action. Action 710 specifies that search bar wizard 410 shall first ask for a target employee to be specified and then navigate to a bonus page associated with the target employee. Paraphrase 720 includes a presentation paraphrase of “Give spot bonus to . . . ” The three periods at the end of the presentation paraphrase are used to indicate to the user that additional information is being requested by action 710.

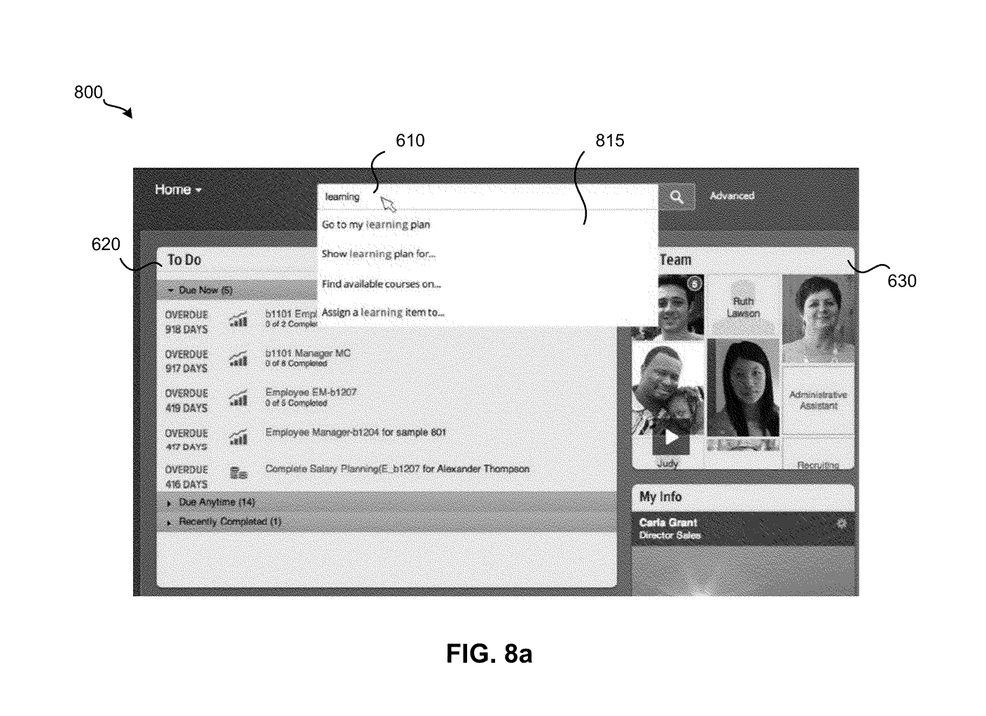

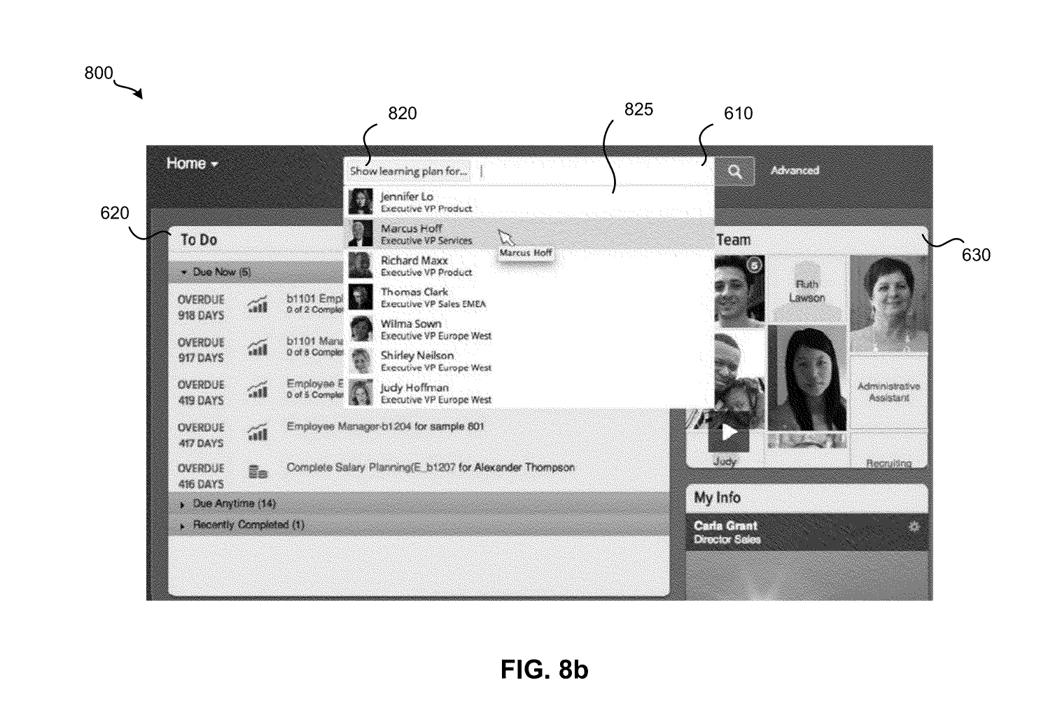

FIG. 8a illustrates another execution of an action search according to one embodiment. Window 800 includes search bar 610, tile 620, and tile 630. A user has entered search query “learning” into search bar 610. In response to the search query, search bar wizard 410 returns four search results in dialog box 815, which drops down from search bar 610. Three of the search results are related to transitive actions since they include three periods at the end of the presentation paraphrase. The presentation paraphrase “show learning plan for . . . ” is associated with an action to show a learning plan for a person within the organization. The presentation paraphrase “find available courses on . . . ” is associated with an action to show a list of courses related to a particular topic or subject. The presentation paraphrase “assign a learning item to . . . ” is associated with an action to assign a learning item to a person within the organization.

FIG. 8b illustrates the window of FIG. 8a after selecting the presentation paraphrase to show learning plan for a person within the organization according to one embodiment. As shown, search bar 610 has been populated with the previously selected presentation paraphrase 820. This describes the action that is being performed and requests the selection of an object (e.g., person within the organization) to apply the action to. As shown, a list of people within the organization are presented in pop up window 825. In some embodiments, search bar wizard 410 can perform a query for people within the organization that are accessible to the user submitting the search query. Depending on the action, a person can be accessible if the person directly reports to the user submitting the search query. Alternatively, a person can be accessible if the user submitting the search query has rights to assign tasks to the person, view details on the person, or edit details on the person. In one example, search bar wizard 410 can list employees whom the user submitting the query has access to or can perform the action to. Thus, search bar wizard 410 presents a list of individuals within the organization where the user has access to their learning plan. Upon selecting of an individual from pop up window 825, search query wizard 410 can present a user interface for viewing the learning plan for the individual. Alternatively, search query wizard 410 can transmit parameters to another application which is configured to present the learning plan. In some embodiments, search bar wizard 410 can perform queries for people, classes, or other objects which are accessible by, belong to, or controlled by the user submitting the search query. In other examples, the query for people can depend on the role or the position of the user within the organization.

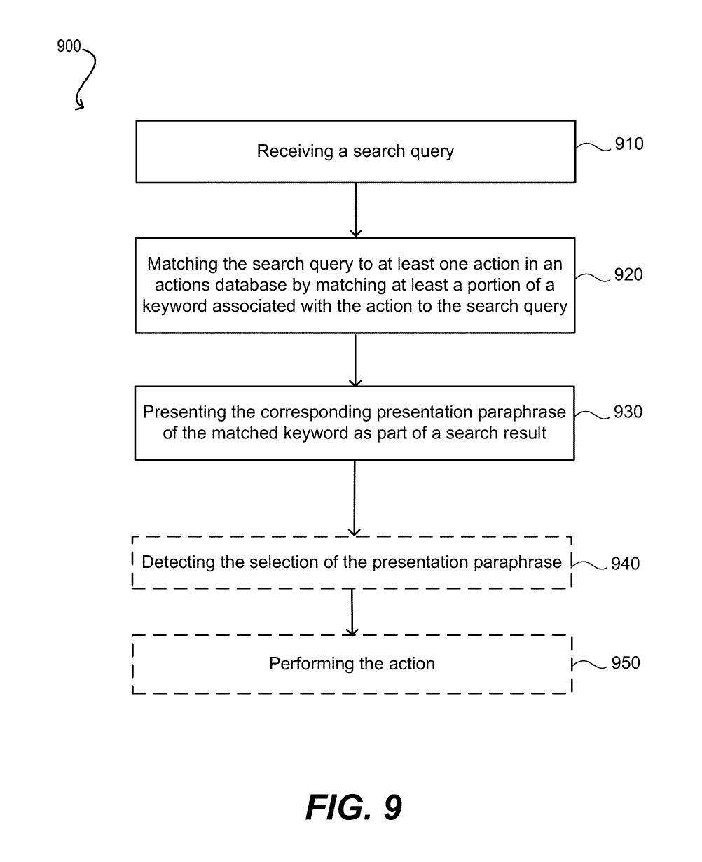

FIG. 9 illustrates a process according to one embodiment. Process 900 can be stored as non-transitory computer readable media and executed by a processor. For example, process 900 can be executed by a processor within administrator device 110, user device 120, or quick action module 140. Process 900 is configured to present search results in response to a search query. The search results may be presentation paraphrases. In some examples, the presentation paraphrases may contain words other than the search query. For example, a search query for the term “rewards” can return the presentation paraphrase “give spot bonus to . . . ” As shown, the presentation paraphrase does not contain words that are present in the search query.

Process 900 begins by receiving a search query at step 910. The search query can be received within a search bar. After receiving the search query, process 900 continues by matching the search query to at least one action in an actions database at step 920. Process 900 can match the search query to an at least a portion of a keyword associated with the action to the search query. After a match is found, process 900 can continue by presenting the corresponding presentation paraphrase of the matched keyword as part of a search result at 930. The search results can be presented in a drop down dialog box from the search bar. Process 900 can optionally continue by detecting the selection of the presentation paraphrase at 940. If a presentation paraphrase has been selected, the process 900 can continue by performing the action at 950.

In some embodiments, metrics can be collected on frequency of certain search queries. Quick action module can analyze the metrics to adjust the keywords (i.e., matching paraphrases) and/or the presentation paraphrases. For example, quick action module can flag or track search queries which frequently do not match any keywords of the paraphrases. Quick action module can optionally recommend a flagged search query as a potential keyword for administrators to add into one or more actions.

In other embodiments, quick action module may remove common words such as “a,” “the,” and “I” from the search query. By removing common words, the search query can be simplified to assist in targeting the search. In other embodiments, the quality of a presentation paraphrase that is presented in response to the user's search query can be measured. For example, the user provide a rating for a presentation paraphrase. If the presentation paraphrase consistently gets a bad rating for a given search query, then quick action module can notify the actions design module to recommend changing the paraphrase that corresponds with the action. In another embodiment, quick action module can prioritize the search results according to how often the search result is accessed by a given user or a group of users. This allows search results which are frequently selected by the user(s) to appear in front of search results which are rarely selected by the user(s). Thus, frequently selected search results can be prioritized and given a higher spot in the search results.

Computer system 1010 may be coupled via bus 1005 to a display 1012, such as a cathode ray tube (CRT) or liquid crystal display (LCD), for displaying information to a computer user. An input device 1011 such as a keyboard and/or mouse is coupled to bus 1005 for communicating information and command selections from the user to processor 1001. The combination of these components allows the user to communicate with the system. In some systems, bus 1005 may be divided into multiple specialized buses.

Computer system 1010 also includes a network interface 1004 coupled with bus 1005. Network interface 1004 may provide two-way data communication between computer system 1010 and the local network 1020. The network interface 1004 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 1004 sends and receives electrical, electromagnetic, or optical signals that carry digital data streams representing various types of information.

Computer system 1010 can send and receive information, including messages or other interface actions, through the network interface 1004 across a local network 1020, an Intranet, or the Internet 1030. For a local network, computer system 1010 may communicate with a plurality of other computer machines, such as server 1015. Accordingly, computer system 1010 and server computer systems represented by server 1015 may form a cloud computing network, which may be programmed with processes described herein. In the Internet example, software components or services may reside on multiple different computer systems 1010 or servers 1031-1035 across the network. The processes described above may be implemented on one or more servers, for example. A server 1031 may transmit actions or messages from one component, through Internet 1030, local network 1020, and network interface 1004 to a component on computer system 1010. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method, comprising:
receiving, by a processor, a search query;
matching, by the processor, the search query to an action in an actions database by matching at least a portion of at least one keyword associated with the action to the search query, wherein the action is configured to perform a task in a software application;
presenting, by the processor, a presentation paraphrase associated with the matched keyword as part of a search result;
receiving, by the processor, user input representative of selecting the presentation paraphrase from the search result; and
performing, by the processor, the action in response to the user input.

2. The computer-implemented method of claim 1, further comprising:
matching, by the processor, the search query to an employee within an organization by comparing a name of the employee to the search query; and
presenting, by the processor, the name of the employee within the organization as part of the search result.

3. The computer-implemented method of claim 1, wherein the action includes a many-to-one mapping between a plurality of keywords and the presentation paraphrase.

4. The computer-implemented method of claim 1, wherein the action is a deep link into the software application.

5. The computer-implemented method of claim 4, wherein the search query is received from an employee and wherein the deep link is provided along with one or more parameters describing the employee.

6. The computer-implemented method of claim 1, wherein performing the action comprises:
presenting, by the processor, an action card configured to receive data to perform the task;
receiving, by the processor, user input representative of entering the data into the action card; and
passing, by the processor, the data to the software application to perform the task.

7. The computer-implemented method of claim 1, wherein the search query is submitted by a user and wherein performing the action comprises:
determining, by the processor, that the action is a transitive action to be performed on another user;
querying, by the processor, an employee database for a list of users that directly report to the user submitting the search query; and
presenting, by the processor, the list of users in conjunction with the presentation paraphrase.

8. A non-transitory computer readable storage medium storing one or more programs, the one or more programs comprising instructions for:
receiving a search query;
matching the search query to an action in an action database by matching at least a portion of at least one keyword associated with the action to the search query, wherein the action is configured to perform a task in a software application;
presenting a presentation paraphrase associated with the matched keyword as part of a search result;
receiving user input representative of selecting the presentation paraphrase from the search result; and
performing the action in response to the user input.

9. The non-transitory computer readable storage medium of claim 8, further comprising:
matching the search query to an employee within an organization by comparing a name of the employee to the search query; and
presenting the name of the employee within the organization as part of the search result.

10. The non-transitory computer readable storage medium of claim 8, wherein the action card includes a many-to-one mapping between a plurality keywords and the presentation paraphrase.

11. The non-transitory computer readable storage medium of claim 8, wherein the action is a deep link into the software application.

12. The non-transitory computer readable storage medium of claim 11, wherein the search query is received from an employee and wherein the deep link is provided along with one or more parameters describing the employee.

13. The non-transitory computer readable storage medium of claim 8, wherein performing the action comprises:
presenting an action card configured to receive data to perform the task;
receiving user input representative of entering the data into the action card; and
passing the data to the software application to perform the task.

14. The non-transitory computer readable storage medium of claim 8, wherein the search query is submitted by an employee and wherein performing the action comprises:
determining that the action is a transitive action to be performed on another employee;
querying an employee database for a list of employees that directly report to the employee submitting the search query; and
presenting the list of employees in conjunction with the presentation paraphrase.

15. A computer implemented system, comprising:
one or more computer processors; and
a non-transitory computer-readable storage medium comprising instructions, that when executed, control the one or more computer processors to be configured for:
receiving a search query;
matching the search query to an action in an action database by matching at least a portion of at least one keyword associated with the action to the search query, wherein the action is configured to perform a task in a software application;
presenting a presentation paraphrase associated with the matched keyword as part of a search result;
receiving user input representative of selecting the presentation paraphrase from the search result; and
performing the action in response to the user input.

16. The computer implemented system of claim 15, further comprising:
matching the search query to an employee within an organization by comparing a name of the employee to the search query; and
presenting the name of the employee within the organization as part of the search result.

17. The computer implemented system of claim 15, wherein the action is a deep link into the software application.

18. The computer implemented system of claim 17, wherein the search query is received from an employee and wherein the deep link is provided along with one or more parameters describing the employee.

19. The computer implemented system of claim 15, wherein performing the action comprises:
presenting an action card configured to receive data to perform the task;
receiving user input representative of entering the data into the action card; and
passing the data to the software application to perform the task.

20. The computer implemented system of claim 15, wherein the search query is submitted by an employee and wherein performing the action comprises:
determining that the action is a transitive action to be performed on another employee;
querying an employee database for a list of employees that directly report to the employee submitting the search query; and
presenting the list of employees in conjunction with the presentation paraphrase.
